(19) United States
(12) Patent Application Publication
(10) Pub. No.: US 2008/0176580 A1
(43) Pub. Date: Jul. 24, 2008

(54) Cellular Telephone Tracking System Employing a Gps

(76) Inventor: Michael Keith Dery, Flint, MI (US)

Correspondence Address: The Weintraub Group, 32000 Northwestern Highway, Suite 240, Farmington Hills, MI, 48334, US

(21) Appl. No.: 11/885,464

(22) PCT Filed: Mar. 3, 2006
(86) PCT No.: PCT/US06/07695

§ 371 Date: Aug. 31, 2007

Related U.S. Application Data
(60) Provisional application No. 60/658,086, filed on Mar. 3, 2005.

(51) Int. Cl. H04Q 7/20

(52) U.S. Cl. 455/456.1

(57) ABSTRACT

A system for tracking a mobile telephone having a GPS receiver, the mobile telephone receiving instruction to transmit to a cellular tower its position and identification. The system including a server for receiving a signal from a cellular tower and from a client. The system includes a sub-system for receiving a signal representative of the mobile telephone location and identification; a sub-system for storing the mobile telephone location and identification; and a subOsystem for transmitting location data and phone identification data to a logged client.

### CROSS-REFERENCE TO RELATED APPLICATIONS

This Application claims priority under 35 USC Section 119 from co-pending U.S. Provisional Patent Application Ser. No. 60/658,086, filed Mar. 3, 2005, the entire contents of which being specifically incorporated herein by reference.

### FIELD OF THE INVENTION

The present invention relates to a system for tracking a mobile communication device, such as a cellular telephone, and more specifically, the present invention relates to a system for tracking a mobile communication device having a receiver, such as a GPS receiver or differential GPS (dGPS) receiver and instructions to transmit to a wireless network a signal representative of the wireless communications device location and identification.

### BACKGROUND OF THE INVENTION

Cellular telephones have become a standard medium for communications. Many companies issue their employees cellular telephones to maintain contact. Delivery drivers often have cellular telephones to keep company dispatchers informed regarding their progress.

Cellular telephones are mobile wireless devices that use radio signals to communicate with a transmitter. As a cellular telephone moves from one overlapping cell to another, the signal is switched from one transmitter to another.

Recently, location tracking technology has been integrated into cellular telephones by employing a global positioning system (GPS). It is known in the art to use assisted GPS (AGPS) to provide location of a cellular phone in the event of a 911 call. This is achieved by measuring the location of the cellular phone relative to one or more cellular towers. Current cellular telephones also receive signals directly from GPS satellites. More recently, true GPS has been added to mobile phones by manufactures, as true GPS is more precise than AGPS.

GPS is a satellite-based navigation system that works by receiving navigation messages from three or more satellites and calculating locations based on the relative distance from each satellite. All GPS satellites have clocks set to exactly the same time. The satellites know their exact position from data sent to them from systems controllers. Each satellite transmits its position and time signal, which can be received by a GPS receiver. GPS receivers locate the satellites transmitting the incoming signals and use a CDMA (Code Division Multi Access) method to identify individual codes. The GPS receiver can read each satellite's unique identification to calculate the precise location of the receiver. The GPS receiver records the time signals, which are delayed by the distance traveled by the signal. The distance from the satellites is calculated by the difference in time between when the signal was sent from the satellite and received by the receiver. The receiver calculates its own position.

As GPS is readily available, a more efficient means of tracking a mobile phone may be employed, rather than by voice communications with an employee, for example. A cellular telephone tracking system, employing a cellular telephone that has a GPS receiver, would provide many advantages. The driver would not need to be distracted from his job in order to communicate his progress with the dispatcher. In the event of an emergency, the dispatcher can determine the user's last location.

One such system that combines cellular telephone technology with a GPS system is described in U.S. Pat. No. 5,786,789. The '789 patent discloses a GPS unit and a cellular telephone unit each having add-on modules for providing additional functionality. A battery powered hand-held GPS unit has a battery power module with a built-in cellular telephone. The controls on the GPS unit are used to control cellular telephone operations. The GPS controlled cellular telephone transmits position location information obtained by the GPS unit. Although this combination provides for a GPS system, it is not an integrated product. Furthermore, the '789 patent does not disclose a tracking component for transmitting location information to a client.

Another such system that combines cellular telephone technology with a GPS system is described in U.S. Pat. No. 6,813,500. The '500 patent discloses a cellular telephone having a GPS receiver using a blended combination of GPS signals from GPS satellites and GPS pseudolites for determining a location. Although this system provides an integrated GPS receiver and an improvement over the art for acquisition speed, it does not disclose a tracking component for transmitting location information to a client.

Still another such system that combines cellular telephone technology with a GPS system is described in U.S. Pat. No. 6,501,420. The '420 patent discloses a mobile cellular telephone comprising a communications transmitter and receiver arranged for two-way communication with a base station and a GPS receiver arranged to power up in response to direct interaction between a user and the mobile phone after the telephone has been switched on. The power up in response feature is an advantage, however, the system still does not provide a tracking component for transmitting location information to a client.

One system that provides a web based navigation system is described in U.S. Pat. No. 6,473,030. The '030 patent discloses a navigation system that comprises a cell-phone, a base cellular telephone site, and a web based server, each of which is paired with a GPS receiver. The GPS receiver associated with the cell-phone is aided with information received from the cell-site and webserver that help reduce satellite search uncertainty. Although this system provides an improvement over the art for low cost correctional systems, it does not disclose a tracking component for transmitting location information to a client.

Thus, it is desirable to provide a cellular telephone tracking system for providing the location of a cellular telephone having a GPS receiver, where the location data may be transmitted to a client. It is also desirable to provide a web based system and program for tracking the location of a GPS enabled cellular telephone.

### SUMMARY OF THE INVENTION

A system for providing the location of a wireless communications device, such as a cellular phone, having a GPS receiver comprises a wireless communications device having an antenna for receiving a GPS signal from a GPS satellite and for two way communication with a wireless network, such as a cellular tower, a GPS signal processor, memory storage and a microprocessor. The wireless communications device is adapted to receive a sub-system containing instructions to transmit to a network, such as one or more cellular towers, a signal representative of the wireless communications device location and identification. A server operating within a network is capable of receiving a signal from a cellular tower or other network and from a client.

The system includes a sub-system for transmitting a signal representative of wireless communications device location and identification from a wireless communications device to a wireless network and sub-system for receiving a signal representative of wireless communications device location and identification from the wireless communications device.

The system includes a sub-system for parsing the signal representative of wireless communications device location and identification into location data and wireless communications device identification data and a sub-system for storing the location data and wireless communications device identification data. A sub-system for determining whether the client is logged into the system may also be provided.

The system further comprises a sub-system for transmitting location data and wireless communications device identification data to the client if the client is logged into the system. Additionally, the location data and wireless communications device identification data may be associated with a user. A sub-system generates a web page and transmits the web page to the client. The web page transmitted to the client may include at least one interface, such as a map, a spreadsheet, user data and client tools. A user's course may be tracked on a map at the client location.

A computer program embodied on a computer readable medium for providing the location of a wireless communications device having a GPS receiver comprises a code segment for transmitting a signal representative of wireless communications device location and wireless communications device identification from a wireless communications device to a wireless network, such as a cellular tower, where the wireless communications device, such as a cellular telephone, has an antenna for receiving a GPS signal from a GPS satellite and for two way communication with a wireless network, such as a cellular tower, a GPS signal processor, memory storage and a microprocessor. A code segment receives the signal representative of location from the wireless communications device by a server, where the server is operating in a network capable of receiving a signal from, for example, a cellular tower and from a client.

A code segment parses the signal representative of wireless communications device location and identification into location data and wireless communications device identification data. A code segment stores the location data and wireless communications device identification data. A code segment determines whether the client is logged into the system.

The computer program further comprising a code segment for transmitting location data and wireless communications device identification data to the client if the client is logged into the system. The computer program associates the location data and phone identification data with a cellular phone user. A user's course may be tracked on a map at the client location. Additionally, a client may also be a wireless communications device, in which case two or more wireless communications devices may be aware of their relative locations, relative velocity, convergence or divergence.

Further objects, features and advantages of the present invention will become apparent to those skilled in the art from analysis of the following written description, the accompanying drawings and the appended claims.

### BRIEF DESCRIPTION OF THE DRAWINGS

FIG. 1 is a schematic illustration of a system for tracking a cellular telephone employing a GPS receiver according to the principles of the present invention; and

FIG. 2 is a block diagram revealing a wireless communication device and server in further detail;

FIGS. 3a through 3c reveal sample screens displayed by a tracking program according to principles of the present invention; and

FIG. 4 is a block diagram of a system for conducting electronic transactions according to the principles of the present invention.

### DESCRIPTION OF THE PREFERRED EMBODIMENT

A system for tracking a wireless communications device employing a GPS receiver, such as a GPS enabled cellular telephone, enables a client to monitor the location of the wireless communications device by employing a wireless communications device with a transponder or any substitute device or system known in the art for automatically responding to an incoming signal. Through a server based computer program, a client can monitor the location, velocity, direction, sudden change in direction, for example an accident, no motion for an extended period, presumably a period longer than a typical delivery, a sales call, a stop light or an employee frolic or detour. As used herein, a GPS receiver is intended to include a GPS receiver or differential GPS (dGPS)receiver.

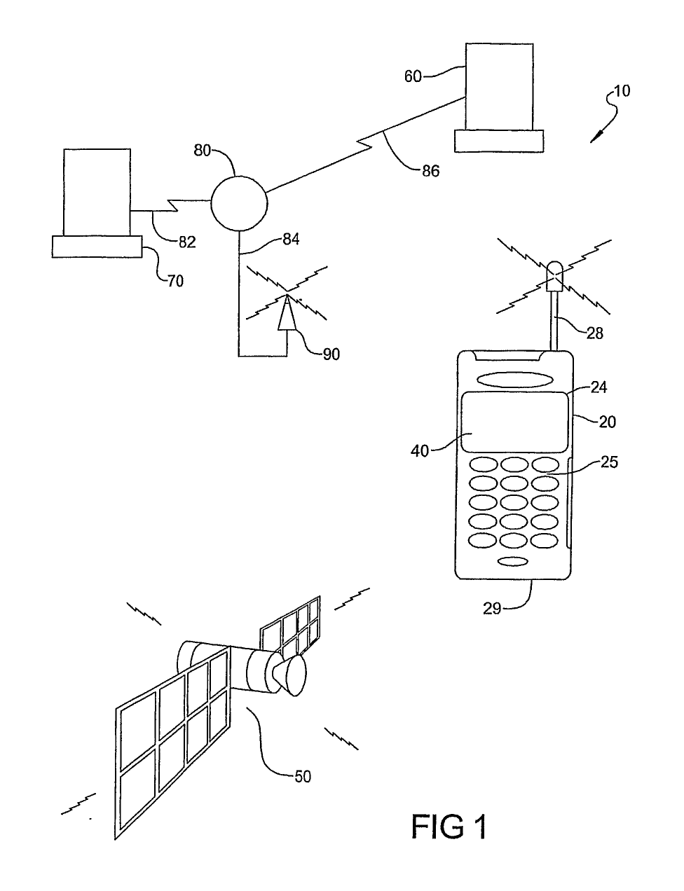

With initial reference to FIG. 1, a schematic illustration of a system 10 for providing software and data to a wireless communications device 20, for example a cellular telephone having a GPS enabled receiver, according to the principles of the present invention is shown. The system 10 comprises a provider server 70 in communication with a network 80, such as the Internet or a wireless network, via a line 82. The network 80 is in communication with a cellular network 90 via a line 84. The provider server 70 is accessible by a client 60, such as a personal computer or other terminal, via a line 86, a PBX, or any data transmission system known in the art. The client 60 may be a thin client or include storage devices such as CD-R, CD-RW, DVD-R, DVD-RW, removable hard drive, a floppy drive pin drive magnetic tapes storage or other optical storage for archiving data acquired by the system 10. A satellite 50 transmits its position and time signal, which can be received by a cellular telephone 20 having a GPS receiver.

In the present embodiment, the device 20 is a cellular telephone having an antenna 28, for receiving a GPS Signal from a GPS satellite 50 and for two way communication with a cellular tower (not shown). As used herein, the term wireless network includes not only a cellular network employing towers, but also all other wireless networks know in the art, such as IEEE 802 employing systems such as hub and spoke or mesh, as examples. Device 20 also includes a display screen 24, key pad 25, memory card reader 27 and an I/O port 29. Data and software may be downloaded by wireless communications, such as radio signals, laser or infrared, wire communications, such as through the IO port 29, or from external media, such as a memory card through card reader 27. The IO port 29 enables the device 20 to couple to a cradle (not shown) or any other means known in the art to send and receive data. The device 20 may send and receive data and software via the cellular network 90 or any wireless network, instead of, or in addition to, data and software sent through IO port 29. It should be noted however, that any communication technology known the art including infrared, laser, or radio, such as Bluetooth®, may be employed to transmit and receive data or software within the network 80. The network 80 preferably incorporates secure data transmission for login over a network such as hyper text transfer protocol secure (HTTPS).

Although device 20 in the present embodiment is a cellular telephone, it should be apparent to those skilled in the art that any wireless device may be substituted for a cellular telephone including, but not limited to, a PDA (personal digital assistant), a handheld computer, or any device that comprises memory storage, and microprocessor and may be adapted to receive a transponder. Transponder as used herein should be understood to include any device or system for automatically responding to an incoming signal.

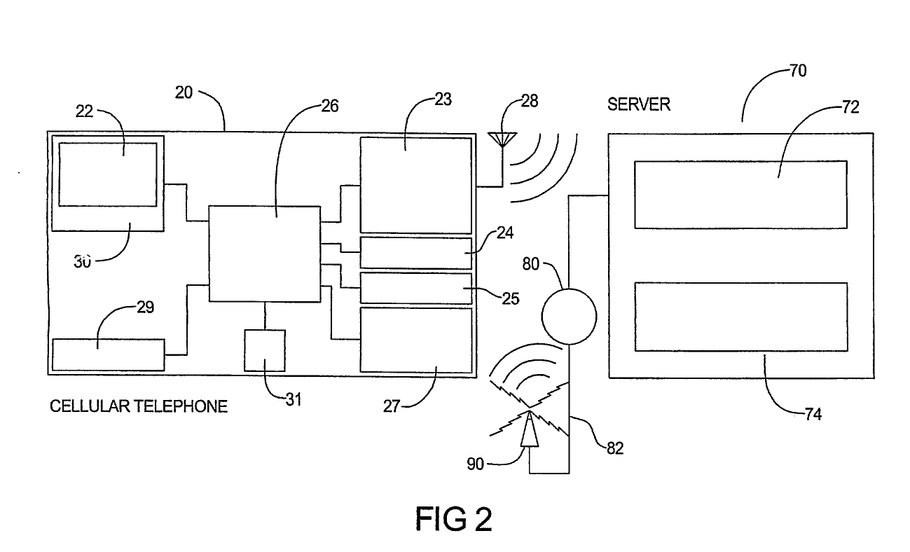

Referring now also to FIG. 2, a block diagram of a system 10 revealing a wireless communication device 20 and server 70 in further detail according to the principles of the present invention are shown. The server 70 has a database 72 and a proprietary computer program 74 that transmits data and code segments to wireless communications device 20. The computer program 74 transmits a code segment 30 to wireless communications device 20 that contains instructions to transmit to a cellular tower a signal representative of the cellular telephone location and identification, for example the cellular telephone number. Once the code segment 30 is installed on the device 20, the client 60 will be able to track the location of the device 20. The device 20 will emit a signal to the server 70 through network 90.

The server 70 has a database 72 for storing customer information as well as data received from wireless communications device 20. The data may be provided in real time or near-real-time to the client 60. The data may be manipulated to provide performance evaluation and recordkeeping on the server or transmitted to the client 60 for processing. Data storage may be accomplished by any data management systems known in the art, including popular systems such as Oracle, IBM DB2, Microsoft SQL, Microsoft Access and Microsoft Excel.

The computer program 74 sends code segment 30 to the wireless communications device 20 once the cellular telephone 20 has been registered with the system 10. The device 20 has a memory storage 22 and a microprocessor 26. The code segment 30 is stored in the memory storage 22 of device 20. The code segment 30 contains instructions executable by the microprocessor 26 to enable the device 20 to transmit a signal representative of cellular telephone location and identification from the cellular telephone 20 to, for example, a cellular tower. The cellular telephone 20 may employ function electronics 23 for GPS signal processing or independent GPS signal processing electronics 31.

In the preferred embodiment, the code segment 30 is a computer program. Examples of the computer program include, but are not limited to, embedded applications that may be extensible, any programming language or embedded development system, including, for example, Java 2 Mobility extensibility (J2ME) and Microsoft Visual Studio.

The system 10 provides the location of a cellular telephone 20 having a GPS receiver, where the cellular telephone 20 has an antenna 28 for receiving a GPS signal from a GPS satellite 50 and for two way communication with a cellular tower (not shown), a GPS signal processor (23,31), memory storage 22 and a microprocessor 26. The cellular telephone 20 is adapted to receive a sub-system containing instructions to transmit to a cellular tower a signal representative of the cellular telephone location and identification. The server 70, which operates within the network 80, is capable of receiving a signal from a cellular tower and from the client 60.

The system 10 includes a sub-system for transmitting a signal representative of cellular telephone location and identification from the cellular telephone 20 to a cellular tower. The system 10 also includes a sub-system for receiving a signal representative of cellular telephone location and identification from the cellular telephone 20 by executing instructions contained in a code segment. In the preferred embodiment, the server 70 receives the signal representative of cellular telephone location and identification from the cellular telephone 20 via the network 80.

The system 10 includes a sub-system for parsing the signal representative of cellular telephone location and identification into location data and phone identification data. Although the term cellular telephone location and identification is used herein, it should be understood to include the location and identification of any wireless communications device. In the preferred embodiment, the server 70 stores user information, and location and identification data into the database 72. The system 10 includes a sub-system for determining whether the client 60 is logged into the system 10.

The system 10 further comprises a sub-system for transmitting location data and phone identification data to the client 60 if the client 60 is logged into the system. Additionally, the location data and phone identification data may be associated with a user. In the present embodiment a user is a person who is in custody of the cellular telephone 20. A particular cellular telephone may be assigned to an employee/user, in which case the user's travels are tracked. For example, the client 60 may be located at the user's place of employment, where the system 10 of the present invention is employed to track the movement of user during work hours.

A sub-system generates a web page and transmits the web page to the client 60. The web page transmitted to the client 60 may include at least one interface, such as a map, a spreadsheet, user data and client tools. The present invention may employ any number of geographic information systems known in the art, including Pocket Streets or Microsoft MapPoint. The map may also include push pins to indicate destinations, such as favorite meeting places. A user's course may be tracked on a map at the client location. In the preferred embodiment, once the cellular telephone 20 is powered on, it transmits a signal representative of cellular telephone location and identification to the network 80. Additionally, an alarm may notify the client of a concern, such as excessive velocity, excessive dormancy and a sudden change in direction, or any other position with respect to time related event that could indicate a problem. Additionally, a client 60 may also be a wireless communications device 20, in which case two or more wireless communications devices 20 may be aware of their relative locations, relative velocity, convergence or divergence.

In the preferred embodiment, sub-system operations are achieved by executing instructions to accomplish the desired operation. In one embodiment, each sub-system operation is performed by executing a code segment of program 74.

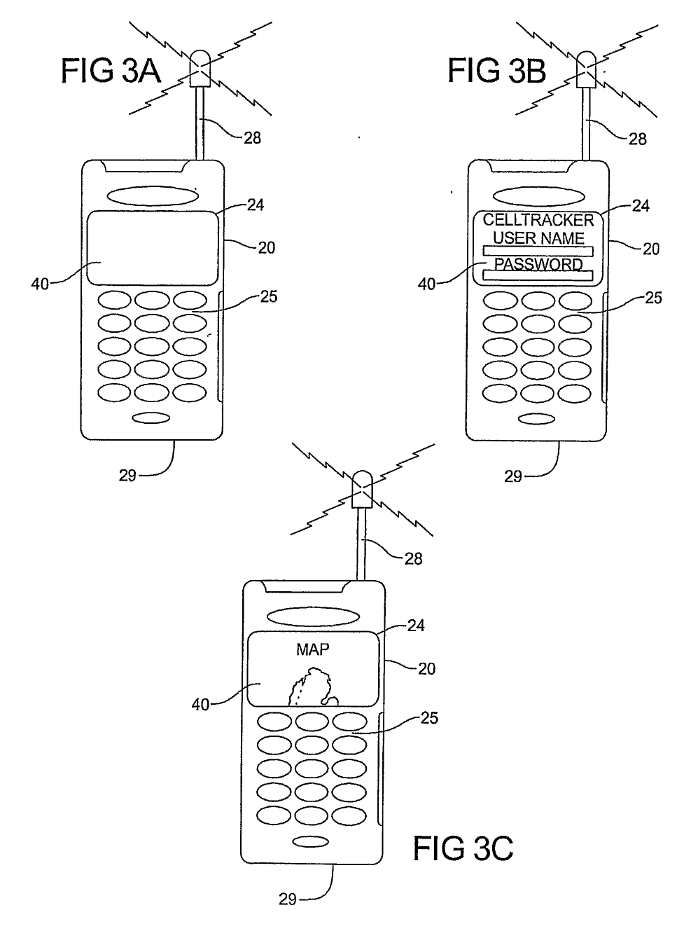

Referring now also to FIGS. 3a through 3c, sample screens displayed by a tracking program 74 according to principles of the present invention are shown. The system operates in two modes of operation: clandestine and visible. In the clandestine mode, a subsystem for transmitting a signal representative of cellular telephone location and identification from a cellular telephone 20 to a cellular tower is non-detectable to a user. The cellular telephone 20 updates the GPS data as continuously as possible, however the application is hidden on the cellular telephone 20. As such, the cellular telephone display 24 will show a normal interface 40, as in the screen of FIG. 3a.

Referring specifically now to FIGS. 3b and 3c, in the visible mode, a sub-system is provided for navigation which generates a map on the cellular telephone 20 when the user logs into the system 10. Additionally, the map may be interactive. The map may show streets on the map and push pins to mark destinations.

When the “on” button is pushed on the cellular phone 20, the program 74 retrieves data including driver/user and vehicle and sends data to the server 70. For example, the cellular telephone 20 may send a browser string to the server 70.

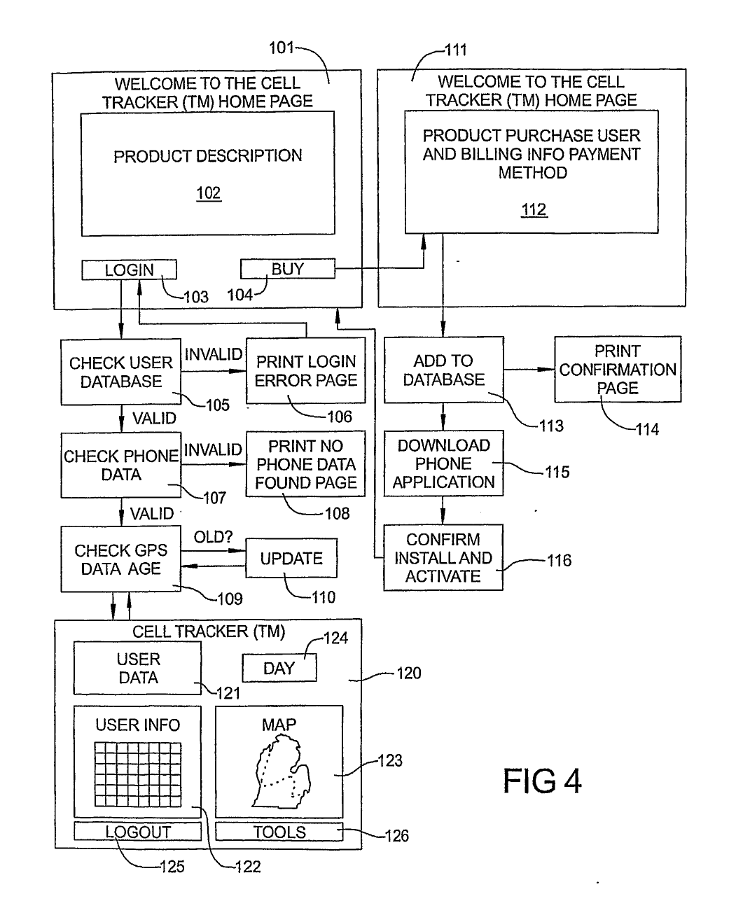

Referring now also to FIG. 4, a block diagram of a system for conducting electronic transactions according to the principles of the present invention is shown. In operation, a customer would log into the Cell Tracker™ home page 101 via the network 80 or a user would log into the system 10 via the cellular telephone 20. The home page 101 displays a product description 102 of the cellular tracking system 10. If the customer has already subscribed, he will follow the login prompt 103 to enter the system 10. The system 10 will interrogate the database 72 to verify the login information during the Check User Database routine 105. If the customer does not exist a Print Error Page routine 106 is executed.

A Check Phone Data routine 107 is executed to determine if the cellular telephone 20 is set up on the system 10. If no phone data is found a Print No Phone Data Found Page routine 108 is executed. If phone data does exist, the system 10 will execute the Check GPS Data Age 109 routine to interrogate the age of the GPS data. If the GPS data age is Old, where Old may be a fixed time span such as, for example 5 seconds, the system 10 will Update 110 the GPS data. If the customer has logged into the system via the client 60, a Cell Tracker™ page 120 is displayed.

If a customer has not yet purchased the Cell Tracker™ service, he would log into the Cell Tracker™ home page 111 via the network 80. The home page 111 displays a Product Purchase routine 112. Once the product is purchased, the customer will be added to the database at routine 113 and a Print confirmation page routine 114 will execute. The server 70 will download the phone application at routine 115 and the setup will be confirmed and activated at routine 116. In the preferred embodiment, once the customer has set the security codes, a user cannot change them.

The foregoing discussion discloses and describes the preferred structure and control system for the present invention. However, one skilled in the art will readily recognize from such discussion, and from the accompanying drawings and claims, that various changes, modifications and variations can be made therein without departing from the true spirit and fair scope of the invention as defined in the following claims.

What is claimed is:

1. A system for providing the location of a wireless communications device having a GPS receiver, comprising:
a wireless communications device having an antenna for receiving a GPS signal from a GPS satellite and for two way communication with a wireless network, a GPS signal processor, memory storage and a microprocessor, said wireless communications device adapted to receive a sub-system containing instructions to transmit to a wireless network a signal representative of the wireless communications device location and identification;
a server operating within a network capable of receiving a signal from a wireless network and from a client;
a client for receiving a signal from a server, the client being capable of logging into the system;
a sub-system for transmitting a signal representative of wireless communications device location and identification from a wireless communications device to a wireless network;
a sub-system for receiving a signal representative of wireless communications device location and identification from said wireless communications device;
a sub-system for parsing the signal representative of wireless communications device location and identification into location data and wireless communications device identification data;
a sub-system for storing the location data and wireless communications device identification data; and
a sub-system for determining whether the client is logged into said system.

2. The system as set forth in claim 1, wherein said client is wireless communications device.

3. The system as set forth in claim 1, further comprising a sub-system for transmitting location data and wireless communications device identification data to said client if said client is logged into said system.

4. The system as set forth in claim 3, wherein the location data and wireless communications device identification data are associated with a user.

5. The system as set forth in claim 4, further comprising a sub-system which generates a web page and transmits the web page to said client.

6. The system as set forth in claim 5, wherein the web page transmitted to said client includes at least one interface, where interface is chosen from the group consisting of a map, a spreadsheet, user data and client tools.

7. The system as set forth in claim 1, wherein said a wireless communications device transmits a signal representative of a wireless communications device location and identification when said wireless communications device is powered on.

8. The system as set forth in claim 1, further comprising a sub-system for navigation which generates a map on said wireless communications device.

9. The system as set forth in claim 8, wherein the map is interactive.

10. The system as set forth in claim 1, wherein said subsystem for transmitting a signal representative of wireless communications device location and identification from a wireless communications device to a wireless network is non-detectable to a user.

11. The system as set forth in claim 4, wherein an alarm notifies said client of a concern, where a concern is selected from the group consisting of velocity, dormancy and change in direction.

12. A computer program embodied on a computer readable medium for providing the location of a wireless communications device having a GPS receiver, comprising:
a code segment for transmitting a signal representative of wireless communications device location and wireless communications device identification from a wireless communications device to a wireless network, the wireless communications device having an antenna for receiving a GPS signal from a GPS satellite and for two way communication with a wireless network, a GPS signal processor, memory storage and a microprocessor;
a code segment for receiving the signal representative of location from the wireless communications device by a server, the server operating in a network capable of receiving a signal from a wireless network and from a client;
a code segment for parsing the signal representative of wireless communications device location and identification into location data and wireless communications device identification data;
a code segment for storing the location data and phone identification data; and
a code segment for determining whether the client is logged into said system.

13. The computer program as set forth in claim 12, further comprising a code segment for transmitting location data and wireless communications device identification data to said client if said client is logged into said system.

14. The computer program as set forth in claim 13, wherein said code segment associates the location data and wireless communications device identification data with a user.

15. The computer program as set forth in claim 14, further comprising a code segment which generates a web page and transmits the web page to the client.

16. The computer program as set forth in claim 15, wherein the web page transmitted to the client includes at least one interface, where interface is chosen from the group consisting of a map, a spreadsheet, user data and client tools.

17. The computer program as set forth in claim 12, wherein said code segment causes the wireless communications device to transmit a signal representative of wireless communications device location and identification when the wireless communications device is powered on.

18. The computer program as set forth in claim 12, further comprising a code segment which generates a map on said wireless communications device to provide for navigation.

19. The computer program as set forth in claim 18, wherein said code segment provides an interactive map.

20. The computer program as set forth in claim 12, wherein said code segment for transmitting a signal representative of wireless communications device location and identification from a wireless communications device to a wireless network is non-detectable to a user.

21. The computer program as set forth in claim 14, wherein said code segment causes an alarm to notify the client of a concern, where a concern is selected from the group consisting of velocity, dormancy and change in direction.

22. The computer program as set forth in claim 12, wherein the client is wireless communications device.
